(19) United States
(12) Patent Application Publication
(10) Pub. No.: US 2015/0295348 A1
(43) Pub. Date: Oct. 15, 2015

(54) PLUG CONNECTION COMPRISING SEALING ELEMENTS

(71) Applicant: SCHAEFFLER TECHNOLOGIES GMBH & CO. KG, Herzogenaurach (DE)

(72) Inventors: Stefan Konias, Erlangen (DE); Jens Hoppe, Erlangen (DE)

(73) Assignee: Schaeffler Technologies GMBH & Co. KG, Herzogenaurach (DE)

(21) Appl. No.: 14/434,231

(22) PCT Filed: Jul. 23, 2013
(86) PCT No.: PCT/DE2013/200069

§ 371 Date: Apr. 8, 2015

(30) Foreign Application Priority Data
Oct. 10, 2012 (DE) 10 2012 218 401.5

(51) Int. Cl. H01R 13/52

(52) U.S. Cl. CPC H01R 13/5219

(57) ABSTRACT

An electrical plug connection that includes a plug (1) provided with contact pins (2), a mating plug (3) having sleeve contacts, and a device for reciprocally bracing the plug (1) to the mating plug (3) once the plugs (1 and 3) have been joined together, and in particular for making contact between an electromagnet of a control valve of a camshaft adjustment system of a reciprocating-piston internal combustion engine, and a control line. Sealing elements (5) are provided that are arranged on the contact pins (2) or sleeve contacts, and these sealing elements (5) can be compressed between the plug (1) and the mating plug (3) when bracing the plugs

### FIELD OF THE INVENTION

An electrical plug connection having a plug that is provided with contact pins, having a mating plug that comprises sleeve contacts and having a device for mutually bracing the plug against the mating plug after joining the plugs together, in particular so as to contact an electromagnet of a control valve of a cam shaft adjuster of reciprocating-piston combustion engines having a control line.

### BACKGROUND

A plug connection of this type for making contact with an electromagnet of a control valve of a cam shaft adjuster of reciprocating-piston combustion engines is known from DE 100 27 080 C2. The electromagnet is attached to the combustion engine preferably to the valve cover and controls the control valve so as to alter the cam shaft adjustment. A plug connection for making contact with the electromagnet by means of a control line is provided on the electromagnet. Since this plug connection is exposed to moisture, grime and operating fluids in the region of the reciprocating-piston combustion engine, the problem arises that the contact pins and contact sleeves of the plug connection become contaminated and as a consequence can compromise the electrical connection.

### SUMMARY

The object of the invention is to develop and improve a plug connection so that a high level of protection against external influences is provided and the electrical contact between contact pins and contact sleeves also remains intact even in the case of difficult environmental conditions.

The object of the invention is achieved by virtue of the fact that sealing elements are provided and said sealing elements are arranged on the contact pins or sleeve contacts and can be compressed between the plug and the mating plug during the assembly process. Prior to the assembly process, the sealing elements are placed on the contact pins or also on the sleeve contacts, if said contact pins or sleeve contacts protrude accordingly out of mating plug, and said sealing elements are subsequently compressed during the assembly process so that they deform as a result of being compressed and produce a sealing connection. The sealing elements are therefore produced from an elastic material, for example rubber, and are deformable.

In a further embodiment of the invention, it is proposed that recesses are provided around the contact pins or sleeve contacts on the plug or on the mating plug and the sealing elements are arranged in these recesses. The sealing elements are formed so that they fit easily into the recesses but comprise a length that is greater than the depth of the recess so that as the plug and mating plug are braced said sealing elements are compressed and consequently lie in a sealing manner against the plug and mating plug and against the contact pins or sleeve contacts.

The wall or the walls of the recesses are embodied so as to taper towards the allocated plug or plug so that a conical or pyramid shape is produced. The circumferential surface or circumferential surfaces of the sealing elements are tailored to suit the wall or the walls accordingly. The singular and plural terms are used when referring to the wall or walls and surface or surfaces because in the case of a conical design a circumferential conical wall is provided, whereas in the case of a pyramid-shaped design multiple walls or surfaces are provided.

In order to facilitate the compression of said sealing elements and to increase the sealing efficiency, the sealing elements comprise at least one recess in the circumferential surface or surfaces and said recess facilitates an easier installation and an easy deformation of said sealing elements. Furthermore, the sealing elements have at least one protruding bulge in the openings that are allocated to the contact pins or sleeve contacts in order to facilitate the assembly process and still ensure sufficient sealing efficiency.

### BRIEF DESCRIPTION OF THE DRAWINGS

For the purpose of further explaining the invention, reference is made to the drawings in which the exemplary embodiment of the invention is illustrated in a simplified manner.

In the drawings:

FIG. 1: is a sectional view through a plug connection in which two contact pins are illustrated,

FIG. 2: is a sectional view rotated by 90° through the plug connection in which one contact pin is visible,

FIG. 3: is a sectional view according to FIG. 2 in an enlarged scale and showing a compressed sealing element,

FIG. 4: is a sectional view according to FIG. 3 prior to compressing the sealing element,

FIG. 5: is a further enlarged sectional view according to FIG. 3 showing a compressed sealing element, and

FIG. 6: is a sectional view according to FIG. 5 showing a sealing element that has not been compressed.

### DETAILED DESCRIPTION OF THE PREFERRED EMBODIMENTS

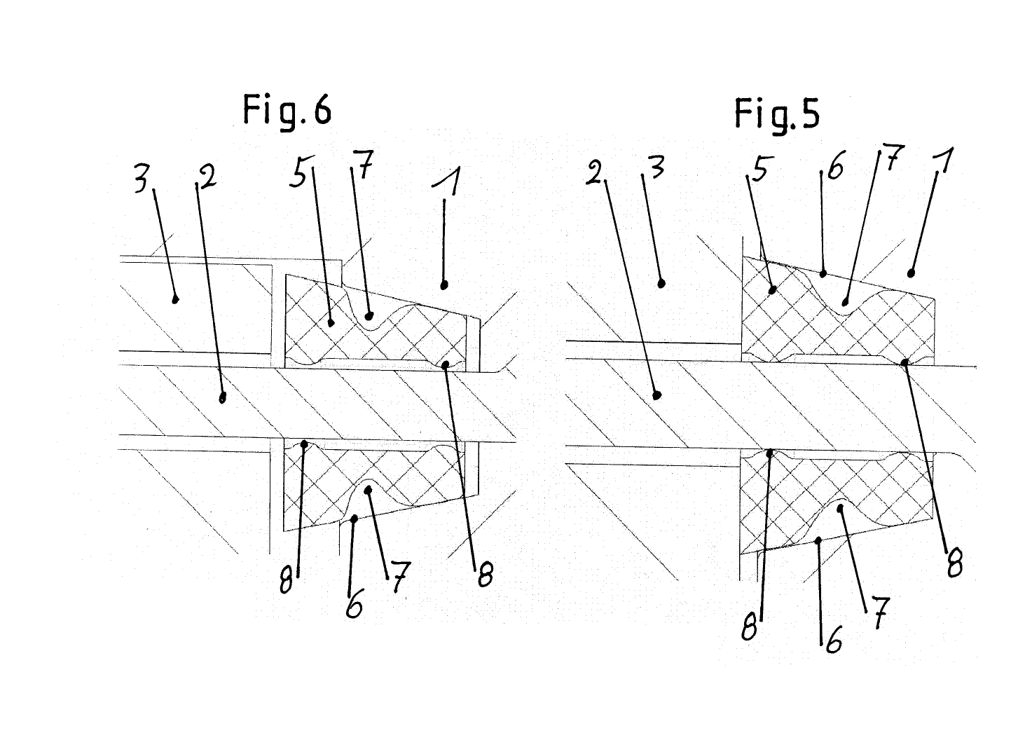

In FIGS. 1 and 6 insofar as is illustrated in detail, the reference numeral 1 describes a plug on which are provided contact pins 2 that protrude out of the inner face of the plug 1. The numeral 3 describes a mating plug in which sleeve contacts, not illustrated, are provided. The contact pins 3 and the sleeve contacts, not illustrated, are electrically connected on the one hand to the electromagnet and on the other hand to a control line. Snap-in protrusions that correspond with undercuts on the mating plug are provided on the extension sleeve 4 of the plug so that after being joined together and braced, the plug and the mating plug are fixed and lock one another in place. Prior to joining the plug 1 and the mating plug 3 together, sealing elements 5 are pushed over the contact pins 2. Recesses 6 are worked in the plug 1 and said recesses are conical or pyramid-shaped. The sealing elements 5 have a corresponding outer shape so that they fit into the recesses 6. As is illustrated particularly in FIGS. 5 and 6, recesses 7 are worked into the peripheral surface or surfaces of the sealing elements 5 and said recesses ensure it is easier to insert the sealing elements 7 into the recesses of the sealing elements 5 and said recesses facilitate the subsequent compression process.

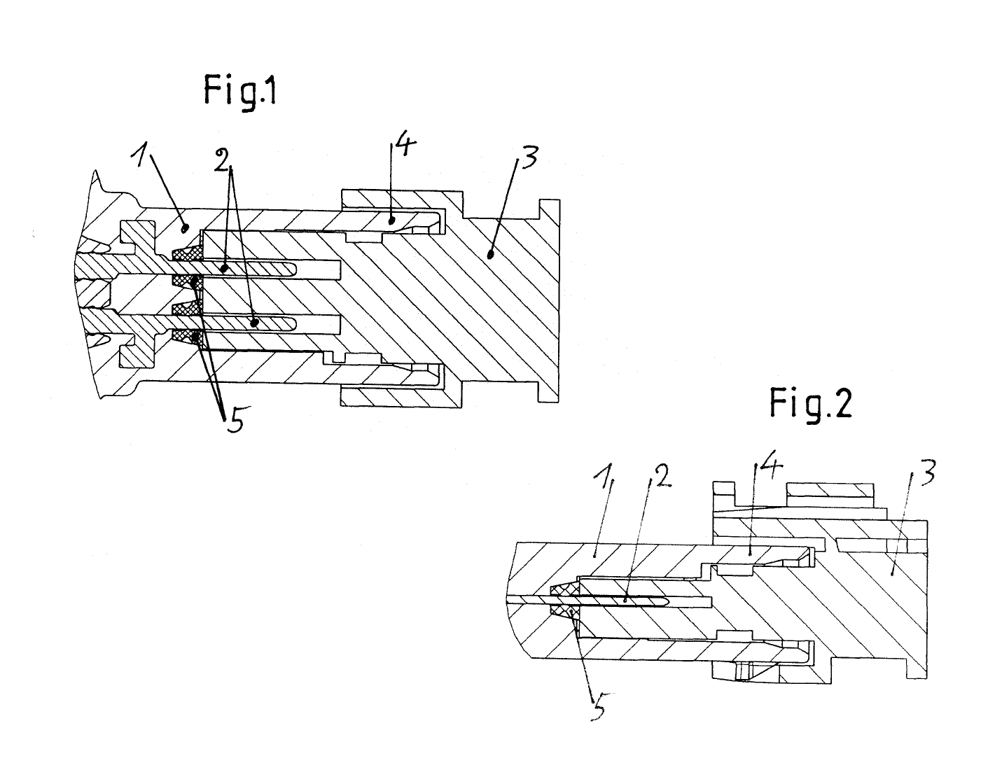

FIGS. 1 and 2 show that the sealing elements 5 are compressed and therefore lie in a sealing manner around the contact pins 2 and fill the recesses 6 in a sealing manner.

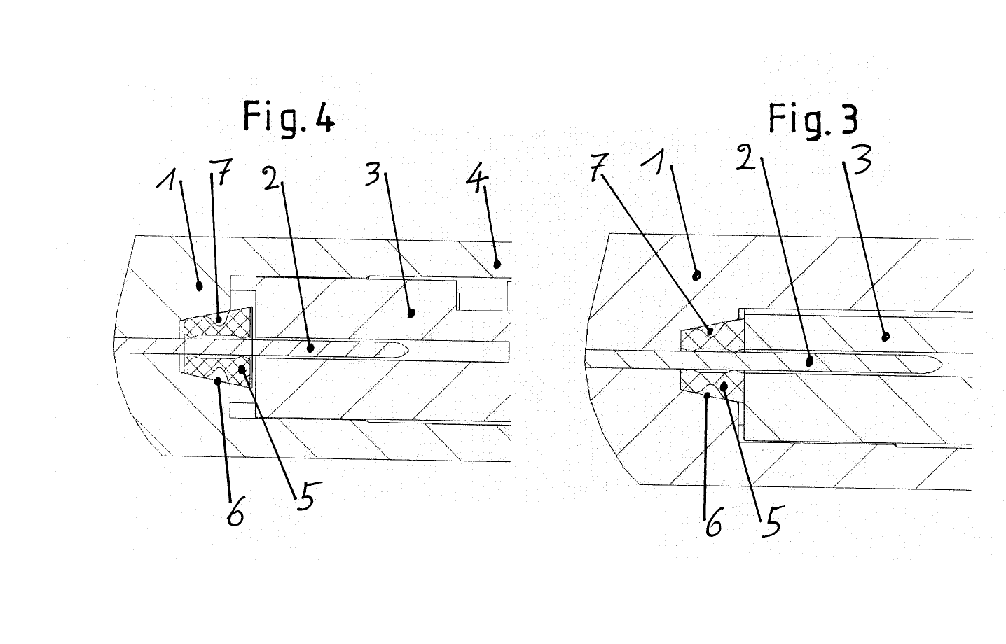

FIG. 4 illustrates a sealing element that is inserted into the recess 6 but is not yet compressed, whereas FIG. 3 illustrates the same sealing element after the process of joining together the plug and mating plug and compressing the sealing element 5.

In the further enlarged illustrations of FIGS. 5 and 6, it is visible that the sealing elements comprise two bulges 8 on the openings that are allocated on the inside of said sealing elements to the contact pins or sleeve contacts; said bulges render it possible to push the sealing elements easily onto the contact pins 2 that produce a sealing contact with the contact pins 2 after the compression process (see FIG. 5). The sealing elements 5 are also inserted outside after the compression process in a sealing manner into the recesses 6.

### LIST OF REFERENCE NUMERALS

1 Plug

2 Contact pins

3 Mating plug

4 Extension sleeve

5 Sealing elements

6 Recesses

7 Recesses

8 Bulges

1. An electrical plug connection comprising: a plug provided with contact pins, a mating plug that comprises sleeve contacts, and a device for mutually fixing the plug onto the mating plug after joining the plug and mating plug together, sealing elements arranged on the contact pins or sleeve contacts and the sealing elements are compressed between the plug and the mating plug as the plug and the mating plug are braced one against the other.

2. The electrical plug connection as claimed in claim 1, wherein recesses are provided around the contact pins or the sleeve contacts on the plug or the mating plug and the sealing elements are arranged in said recesses.

3. The electrical plug connection as claimed in claim 2, wherein a length of the sealing elements is embodied to be greater than a depth of the recesses.

4. The electrical plug connection as claimed in claim 2, wherein a wall or walls of the recesses taper in a direction towards the allocated plug or the mating plug and have a conical or pyramid shape and a circumferential surface or surfaces of the sealing elements are tailored to suit the wall or the walls of the recesses.

5. The electrical plug connection as claimed in claim 1, wherein the sealing elements comprise at least one recess in a circumferential surface or surfaces.

6. The electrical plug connection as claimed in claim 1, wherein the sealing elements comprise at least one protruding bulge in openings that are allocated to the contact pins or the sleeve contacts.
